(19) United States
(12) Patent Application Publication
(10) Pub. No.: US 2018/0233896 A1
(43) Pub. Date: Aug. 16, 2018

(54) SUPPLY DEVICE FOR AN ELECTRICAL MODULE HAVING A FUSE ELEMENT

(71) Applicant: SIEMENS AKTIENGESELLSCHAFT, Muenchen (DE)

(72) Inventors: DANIEL BOEHME, NUERNBERG (DE); INGO EULER, ERLANGEN (DE); THOMAS KUEBEL, ERLANGEN (DE); STEFFEN PIERSTORF, NUERNBERG (DE); DANIEL SCHMITT, POSTBAUER-HENG (DE); FRANK SCHREMMER, FUERTH (DE); TORSTEN STOLTZE, HERZOGENAURACH (DE); MARCUS WAHLE, VEITSBRONN (DE)

(21) Appl. No.: 15/895,130

(22) Filed: Feb. 13, 2018

(30) Foreign Application Priority Data
Feb. 13, 2017 (DE) 10 2017 202 208.6

(51) Int. Cl. H02H 3/10; H02J 7/00; H02M 3/155

(52) U.S. Cl. CPC H02H 3/10; H02J 7/345; H02M 3/155; H02J 7/0052

(57) ABSTRACT

A supply device supplies electrical power to an electrical assembly at a high-voltage potential. The supply device has a series circuit composed of at least one series resistor and a supply unit. The series circuit can be connected to an energy store and the supply unit can be connected to the assembly that is to be supplied with power. The supply device further has a fuse element, by which a short-circuit current through the supply unit can be electrically interrupted in the event of a short circuit.

### CROSS-REFERENCE TO RELATED APPLICATION

This application claims the benefit, under 35 U.S.C. § 119, of German patent application DE 10 2017 202 208.6, filed Feb. 13, 2017; the prior application is herewith incorporated by reference in its entirety.

### BACKGROUND OF THE INVENTION

### Field of the Invention

The invention relates to a supply device for supplying electrical power to an electrical assembly at a high-voltage potential.

Electrical and electronic assemblies that are at a high-voltage potential during operation, that is to say at a potential above 1 kV with respect to ground potential, are known from converter arrangements, for example. A converter arrangement usually has communication assemblies associated with a converter and actuation assemblies for actuating power semiconductor switches of the converter. These and other assemblies require a supply voltage, which has to be provided during operation of the assembly or of the converter.

International patent disclosure WO 2009/003834 A1 (corresponding to U.S. patent publication No. 2010/0176850) discloses a supply device, which provides an energy supply unit arranged at ground potential. The energy supply unit of WO 2009/003834 A1 is connected to the assembly that is to be supplied with power by potential-isolating devices in the form of optical waveguides. The energy is transmitted from the energy supply unit to the assembly by the optical waveguides. Such transmission of supply energy from ground potential to high-voltage potential is relatively complex and costly.

### SUMMARY OF THE INVENTION

The object of the invention is to propose an aforementioned supply device that is as cost-effective and reliable as possible.

In a supply device of the generic type, the invention achieves the object by way of a series circuit composed of at least one series resistor and a supply unit. The series circuit can be connected to an energy store and the supply unit can be connected to the assembly that is to be supplied with power, and a fuse element, by which a short-circuit current through the supply unit can be electrically interrupted in the event of a short circuit.

In accordance with the invention, the supply device is accordingly arranged at a high-voltage potential during operation, like the assembly that is to be supplied with power. A potential isolation between the supply device and the assembly is advantageously omitted. The energy for supplying the assembly with power can be taken from the energy store at a high-voltage potential and provided to the assembly by the supply device. In this way, electrical assemblies that cannot be supplied with energy from ground potential can also advantageously be supplied with energy.

The fuse element fulfills a safety function for the case of a fault in or at the supply unit. In the case of a short circuit in the supply unit, a short-circuit current through the supply unit can arise. The short-circuit current can in this case lead to thermal overloading of the series resistor. In such a case, the fuse element interrupts the short-circuit current and advantageously prevents the overloading. In this way, failure of the insulation of the series resistor and hence destruction of the entire supply unit and adjoining components can be prevented. The fuse element is fittingly arranged in series with the series resistor and with the supply unit. The short-circuit current can be interrupted by interrupting the series circuit, for example. The short-circuit current is interrupted in any case when a current path carrying the short-circuit current is interrupted.

The energy store is fittingly a capacitor or a battery or a series circuit composed of capacitors and/or batteries. The energy store is connected or can be connected to the series circuit by the terminals of the energy store. For connection to the energy store, the series circuit comprises connection terminals, between which the series circuit extends.

The fuse element preferably interrupts the series circuit as soon as a current through the series circuit exceeds a predetermined maximum current value or threshold value. This ensures that the series circuit is interrupted quickly in the event of a short circuit, for example a short circuit at the terminals of the supply unit.

The fuse element is preferably purely passive. A purely passive fuse element itself does not require an additional energy supply or actuation system and is therefore particularly cost-effective and simple to construct.

The fuse element can comprise, for example, a fuse wire, which can be severed in the event of a short circuit. The fuse wire is expediently configured and dimensioned in such a way that it is severed or becomes inoperative in another way in the case of a current that exceeds a predetermined current value. In this way, the series circuit is interrupted in an electrically safe manner. The fuse wire is fittingly arranged in the series circuit, for example between the series resistor and the supply unit. The fuse wire is furthermore configured in such a way that no severing occurs in the case of rated conditions (in particular in the case of a rated current through the series circuit).

The fuse element is preferably a sacrificial element. The sacrificial element interrupts the series circuit, wherein the sacrificial element permanently loses its function, with the result that the function cannot be restored. A particularly reliable isolation or interruption of the electrical series circuit can therefore likewise be achieved.

It is considered to be particularly advantageous when the fuse element is configured in such a way that it at least partly evaporates in the event of a short circuit. In this way, after the series circuit has been interrupted, there are no parts remaining in the supply device that would have to be disposed of accordingly.

A particularly compact form of the fuse element can be achieved when the fuse element is integrated into the series resistor, for example into a housing of the series resistor.

In addition, the at least one series resistor can be realized as a flat resistor. Further series resistors can be arranged in series with the series resistor.

In accordance with one embodiment of the invention, the supply unit contains an actuatable switching element that can be switched on and off. The switching element can be, for example, an IGBT, a MOSFET or similar. The supply unit can also contain a series circuit of a plurality of such switching elements.

The switching element can preferably be actuated in a pulse-like manner by an actuation unit. In this case, during operation, the switching element is switched on and off at short intervals. In accordance with one variant, the switching element can be switched on by the actuation unit when a supply voltage for supplying the assembly with power falls below a predetermined voltage threshold value. There can accordingly be a switch-off or closing when the supply voltage exceeds a further voltage threshold value. In this way, two-pulse actuation is provided, which prevents an overvoltage at the assembly that is to be supplied with power and which can likewise provide power from the energy store as required.

A particularly simple and reliable embodiment of the invention is produced, for example, when the series circuit extends between a first and a second high-voltage-side connection terminal, which are configured for connection to the energy store. The series resistor is connected directly to the first connection terminal, and the supply unit contains a switched-mode power supply, which has a switching element that can be switched on and off and a voltage tap, which are connected to one another in a series circuit. A first connection of the switched-mode power supply is connected to the series resistor and a second connection of the switched-mode power supply is connected to the second connection terminal. A first and a second low-voltage-side connection terminal are arranged at the voltage tap for connection to the assembly that is to be supplied with power.

A resistance element arranged in parallel with the switching unit or with the switched-mode power supply is preferably provided. The additional resistance element and the series resistor can jointly provide the additional function of a discharge resistor for the energy store.

The series circuit preferably extends between a first and a second high-voltage-side connection terminal, which are configured for connection to the energy store. The supply unit contains a variable resistor and a voltage tap in series with the variable resistor, and wherein the fuse element is arranged in series with the supply unit. The variable resistor is expediently realized by a resistance element whose resistance value can be set variably.

The supply device is fittingly dimensioned on the output side and on the energy store side for a voltage of 1 kV to 20 kV. Energy stores of converters in high-voltage installations can therefore also advantageously be used for the supply device.

The supply device is expediently dimensioned on the low-voltage side for a voltage of 100 V to 1 kV. The supply device has a low-voltage side, which can be connected or is connected to the assembly that is to be supplied with power. The supply device can therefore provide a supply voltage between 100 V and 1 kV on the low-voltage side.

The supply unit can be of cascaded design. In this case, at least one further power supply is arranged in parallel with the switching element, for example. The voltage can be further reduced on the low-voltage side depending on application by the further power supply.

The invention is particularly suitable for use in a modular multistage converter. A modular multistage converter contains converter arms extending in each case between a DC voltage pole and an AC voltage connection or between two AC voltage connections. Each converter arm has a series circuit of a plurality of two-pole switching modules. Each switching module contains an energy store and a plurality of power semiconductor switching units, which each have an actuatable semiconductor switch that can be switched on and off. In each of the switching modules, actuation assemblies for actuating the semiconductor switches and the communication assemblies have to be supplied with energy. The energy is expediently supplied by energy being taken from the energy store of the switching module itself. The switching modules can be realized, for example, as half-bridge circuits or full-bridge circuits.

In accordance with one embodiment of the invention, such a switching module for a modular multistage converter is provided, the switching module contains power semiconductor switches and an energy store, wherein the supply device according to the invention is connected in parallel with the energy store.

A particular advantage of this application is the protection against damage to the switching module in the event of short circuits at or in the energy store, the protection being provided by means of the fuse element.

Other features which are considered as characteristic for the invention are set forth in the appended claims.

Although the invention is illustrated and described herein as embodied in a supply device for an electrical module having a fuse element, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of an exemplary embodiment of a switching module having a supply device according to the invention;

FIG. 2 is a schematic illustration of the exemplary embodiment of FIG. 1 in an event of a short circuit; and

FIG. 3 is a schematic illustration of a further exemplary embodiment of the supply device according to the invention.

### DETAILED DESCRIPTION OF THE INVENTION

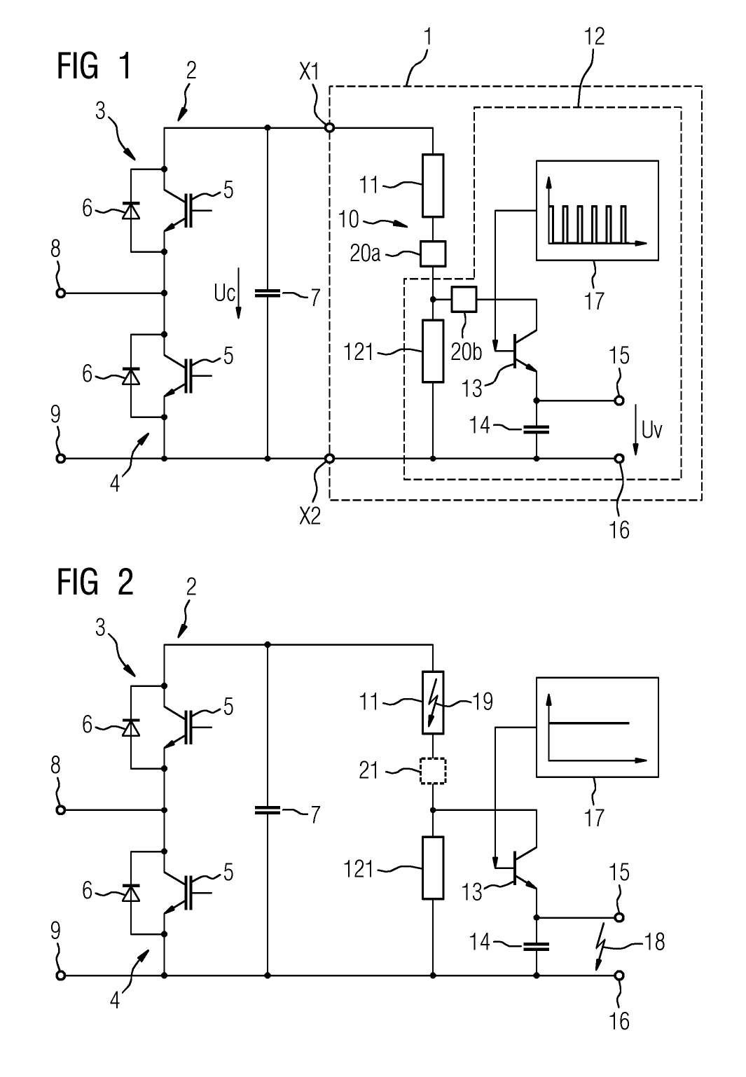

Referring now to the figures of the drawings in detail and first, particularly to FIG. 1 thereof, there is shown a supply device 1 for a switching module 2 of a modular multistage converter. The switching module 2 is constructed in a half-bridge circuit. The switching module 2 thus contains a series circuit having a first power semiconductor switching unit 3 and a second power semiconductor switching unit 4, which each has a semiconductor switch 5 and a freewheeling diode 6. An energy store 7 in the form of a capacitor is arranged in parallel with the two power semiconductor switching units. The switching unit 2 is connected in a series circuit with further structurally identical switching units by the terminals 8 and 9 of the switching unit. During operation of the modular multistage converter, the switching module 2 is at a high-voltage potential that is usually not constant. A voltage Uc of approximately 3 kV is dropped across the energy store 7.

The supply device 1 contains a series circuit 10 composed of a series resistor 11 and a supply unit 12. The supply unit 12 contains a parallel circuit of a further resistance element 121 and a switching element 13. In the exemplary embodiment illustrated, the switching element 13 is an insulated-gate bipolar transistor (IGBT). The series circuit 10 is connected on the high-voltage side in a parallel circuit with the energy store 7.

In the exemplary embodiment illustrated, the supply unit 12 further has a voltage tap in the form of a medium-voltage capacitor 14. Low-voltage side connection terminals 15, 16 are arranged at the medium-voltage capacitor 14. Using the connection terminals 15, 16, the supply device 1 can be connected to the assembly that is to be supplied with power. During operation, a supply voltage Uv of 200 V is applied to the connection terminals 15, 16. If, depending on the assembly, a lower supply voltage, for example of 15 V, is also required, the connection terminals can be connected to a further power supply, which can transform the voltage from 200 V to 15 V.

The gate of the switching element 13 is connected to an actuation system 17. The opening and closing of the switching unit 13 is controlled by the actuation system 17. The actuation is carried out depending on the voltage dropped across the voltage tap 14. If the supply voltage Uv falls below a prescribed threshold value, the switching element 13 is switched on. If the prescribed threshold value is exceeded, the switching element 13 is closed. In this way, a pulse-like actuation of the switching element 13 is produced.

A fuse element 20a is arranged between the series resistor 11 and the supply unit 12. The fuse element 20a is provided to interrupt the series circuit 10 in the event of a fault. The fuse element 20a has a sacrificial element, which is designed in such a way that it evaporates when the series circuit 10 exceeds a current threshold value, wherein the electrical connection between the series resistor 11 and the supply unit 12 is isolated. Alternatively to or in combination with the fuse element 20a, the supply device has a fuse element 20b, which is arranged inside the supply unit 12. In the event of a fault, the fuse element 20b interrupts the short-circuit current through the faulty switching element 13. In the exemplary embodiment illustrated, the fuse elements 20a, 20b are of identical design.

FIG. 2 illustrates the supply device 1 and the switching module 2 of FIG. 1 in the event of a fault. The short circuit on account of a fault in the medium-voltage capacitor 14 or at the connection terminals 15, 16, the short circuit being indicated by the arrow 18, leads to a drop in the supply voltage Uv to zero. The actuation system 17 keeps the switching element 13 permanently open in this case. This in turn leads to a short-circuit current 19 through the series resistor 11 and can lead to thermal overloading of the series resistor.

The short-circuit current 19 is higher than the current threshold value of the fuse element 20a. In the fault event described, the fuse element 20a evaporates, which is indicated in FIG. 2 by a dashed line 21. The short-circuit current 19 is interrupted in this way before the thermal overloading of the series resistor 11 can lead to damage to the supply device 1 or the switching module 2. The fuse element 20b operates correspondingly.

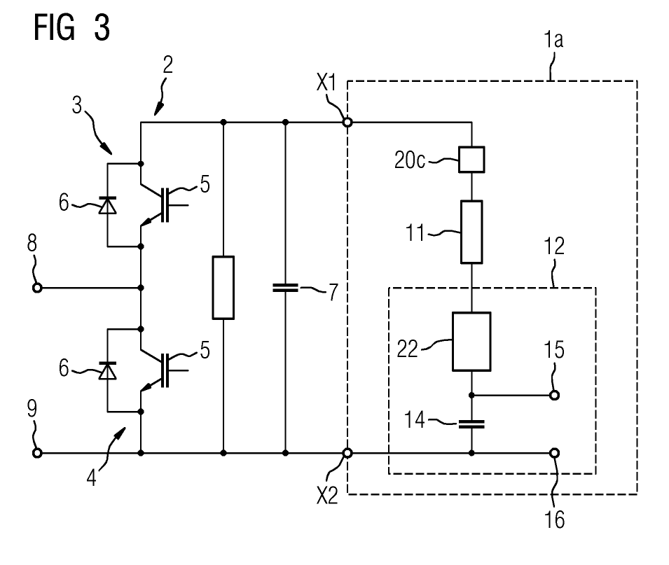

FIG. 3 shows a supply device 1a. Identical and similar elements are in this case provided with identical reference signs in FIGS. 1 to 3.

A fuse element 20c is arranged in series with the supply unit 12. The design of the fuse element 20c corresponds to that of the fuse element 20a. A variable resistor 22 is arranged in series with the voltage tap 14. The variable resistor 22 can contain switch elements, such as semiconductor switches, by which the resistance value of the variable resistor 22 can be increased or decreased.

The switching module 2 can comprise a discharge resistor for the energy store, the discharge resistor being arranged in parallel with the energy store 7.

1. A supply device for supplying electrical power to an electrical assembly at a high-voltage potential, the supply device comprising:
a series circuit composed of at least one series resistor and a supply unit, said series circuit to be connected to an energy store and said supply unit to be connected to the electrical assembly that is to be supplied with the electrical power; and
a fuse element, by means of said fuse element a short-circuit current through said supply unit can be electrically interrupted in an event of a short circuit.

2. The supply device according to claim 1, wherein said fuse element interrupts said series circuit as soon as a current through said series circuit exceeds a predetermined maximum current value.

3. The supply device according to claim 1, wherein said fuse element is purely passive.

4. The supply device according to claim 1, wherein said fuse element contains a fuse wire, which can be severed in an event of the short circuit.

5. The supply device according to claim 1, wherein said fuse element is a sacrificial element.

6. The supply device according to claim 1, wherein said fuse element is configured in such a way that said fuse element at least partly evaporates in an event of the short circuit.

7. The supply device according to claim 1, wherein said fuse element is integrated into said series resistor.

8. The supply device according to claim 1, wherein said at least one series resistor is a flat resistor.

9. The supply device according to claim 1, wherein said supply unit has a switching element that can be switched on and off.

10. The supply device according to claim 9, wherein said supply unit has an actuation unit, said switching element can be actuated in a pulse-like manner by means of said actuation unit.

11. The supply device according to claim 1,
further comprising a first high-voltage-side connection terminal and a second high-voltage-side connection terminal configured for connecting to the energy store, said series circuit extends between said first high-voltage-side connection terminal and said second high-voltage-side connection terminal;
wherein said series resistor is connected directly to said first high-voltage-side connection terminal;
wherein said supply unit has a switched-mode power supply, with a switching element that can be switched on and off and a voltage tap, said switching element and said voltage tap are connected to one another in a series circuit, said switched-mode power supply has a first connection connected to said series resistor and a second connection connected to said second high-voltage-side connection terminal; and
further comprising a first low-voltage-side connection terminal and a second low-voltage-side connection terminal disposed at said voltage tap for connection to the electrical assembly that is to be supplied with the electrical power.

12. The supply device according to claim 11, wherein said supply unit further has a resistance element disposed in parallel with said switching element or in parallel with said switched-mode power supply.

13. The supply device according to claim 1,
further comprising a first high-voltage-side connection terminal and a second high-voltage-side connection terminal;
wherein said series circuit extends between said first high-voltage-side connection terminal and said second high-voltage-side connection terminal, said first high-voltage-side connection terminal and said second high-voltage-side connection terminal are configured for connecting to the energy store;
wherein said supply unit contains a variable resistor and a voltage tap in series with said variable resistor; and
wherein said fuse element is disposed in series with said supply unit.

14. The supply device according to claim 1, wherein the supply device is dimensioned on an energy store side for a voltage of 1 kV to 20 kV.

15. The supply device according to claim 1, wherein the supply device is dimensioned on an output side for a voltage of 100 V to 1 kV.

16. A switching module for a modular multistage converter, the switching module comprising:
power semiconductor switches;
an energy store;
a supply device connected in parallel with said energy store, said supply device containing:
a series circuit composed of at least one series resistor and a supply unit, said series circuit connected to said energy store and said supply unit to be connected to an electrical assembly that is to be supplied with electrical power; and
a fuse element, by means of said fuse element a short-circuit current through said supply unit can be electrically interrupted in an event of a short circuit.
